(19) United States
(12) Patent Application Publication
(10) Pub. No.: US 2015/0355609 A1
(43) Pub. Date: Dec. 10, 2015

(54) CROWDSOURCING AUTOMATION RULES

(71) Applicant: Vivint, Inc., Provo, UT (US)

(72) Inventor: Jeremy B. Warren, Draper, UT (US)

(21) Appl. No.: 14/298,624

(22) Filed: Jun. 6, 2014

(51) Int. Cl. G05B 15/02; H04L 12/28; G06Q 50/00

(52) U.S. Cl. CPC G05B 15/02; G06Q 50/01; H04L 12/2803

(57) ABSTRACT

A method for crowdsourcing automation rules is described. In one embodiment, the method includes creating, via a user interface, a new building automation rule and sending the new building automation rule to an online rule exchange. The online rule exchange is configured to publish the new building automation rule. Accordingly, the method also includes receiving, at the online rule exchange, the new building automation rule created via the user interface and publishing the new building automation rule on the online rule exchange.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of, and continued advancements in, building and residential automation, and building and residential security products and systems. For example, advancements in mobile devices allow users to monitor a home or business from anywhere in the world.

### SUMMARY

According to at least one embodiment, a method for crowdsourcing automation rules is described. In one embodiment, the method may include receiving, at an online rule exchange, a new building automation rule created via a user interface and publishing the new building automation rule on the online rule exchange.

In some embodiments, the method may include evaluating the new building automation rule. In some cases, one or more features of the new building automation rule may be determined based on the evaluation of the new building automation rule. Additionally, or alternatively, one or more categories for the new building automation rule may be determined based on the evaluation of the new building automation rule.

In one embodiment, the method may include collecting usage data of one or more rules on the online rule exchange. In some cases, the one or more rules on the online rule exchange may be sorted in an order determined by an analysis of the usage data. In some embodiments, the method includes learning user preferences and sorting rules on the online rule exchange in an order determined by user preferences.

In one embodiment, the method may include receiving a request to install the new building automation rule on a remote device. In some cases, an existing rule already installed on the remote device may be evaluated. Based on the evaluation of the existing rule installed on the remote device, it may be determined whether an aspect of the new building automation rule conflicts with an aspect of the existing rule.

According to at least one embodiment, a method for crowdsourcing automation rules is described. In one embodiment, the method may include creating, via a user interface, a new building automation rule and sending the new building automation rule to an online rule exchange. The online rule exchange may be configured to publish the new building automation rule.

In one embodiment, the method may include sending, via the user interface, a request to the online rule exchange for information regarding one or more rules on the online rule exchange. In some cases, the request may include information regarding at least one of a rule category, a rule creator, a rule name, rule popularity, a rule rating, a rule review, a featured rule, a rule description, a rule feature, a number of times a rule is downloaded, a number of current users of a rule, a number of executions of a rule, and user preferences.

In some embodiments, a plurality of building automation rules from the online rule exchange may be displayed, via the user interface, in an order determined by information in the request. Based on a user selection, one of the plurality of building automation rules may be downloaded from the online rule exchange.

In one embodiment, the method may include modifying the downloaded building automation rule and sending the modified building automation rule to the online rule exchange. The online rule exchange may be configured to publish the modified building automation rule.

In some embodiments, the method may include incorporating an external service with the downloaded building automation rule. Examples of incorporating external services with the downloaded building automation rule may include associating the rule with one or more settings of an email account, a text messaging account, a cloud computing account, a social media account, an online calendar, a contact list, a location service, and the like. In some cases, the method may include sending a rating of the downloaded building automation rule to the online rule exchange.

A computing device configured for crowdsourcing automation rules is also described. The device may include a processor and memory in electronic communication with the processor. The memory may store instructions that are executable by the processor to receive a new building automation rule created via a user interface of an online rule exchange and publish the new building automation rule on the online rule exchange.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a rules module;

FIG. 3 is a block diagram illustrating one example of a user interface module;

FIG. 4 is a block diagram illustrating one example of a rules exchange module;

FIG. 5 is a block diagram illustrating one example of an environment for crowdsourcing automation rules;

FIG. 6 is a flow diagram illustrating one embodiment of a method for crowdsourcing automation rules;

FIG. 7 is a flow diagram illustrating another embodiment of a method for crowdsourcing automation rules;

FIG. 8 is a flow diagram illustrating another embodiment of a method for crowdsourcing automation rules; and

FIG. 9 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to building and residential automation and security systems. More specifically, the systems and methods described herein relate to crowdsourcing automation rules in relation to a building and residential automation system. Some embodiments of the systems and methods described herein relate to crowdsourcing automation rules in relation to an integration of building or residential automation systems and an online rule exchange.

In a typical automation system, a user may download one or more rules created by the manufacturer of the typical automation system. Due to limited resources, the rules created by the manufacturer may fail to access the full potential of the automation system. There may be circumstances and situations that the basic manufacturer-created rules are not able to handle. Accordingly, benefits may be realized by crowdsourcing the creation of automation rules. In some cases, based on the systems and methods described herein, a manufacturer may release application programming interfaces (APIs) and software development kits (SDKs) to the public, enabling the general public to create custom automation rules. Furthermore, the manufacturer may provide an online rules exchange where the custom automation rules may be made available to users of the online rules exchange. For example, a rules developer may utilize the APIs and/or SDKs to create on or more rules. Upon completing a rule, the developer may upload the completed rule to the online rules exchange. According to the systems and methods described herein, the uploaded rule may be published on the online rules exchange, making the uploaded rule available to users of the online rules exchange. For instance, users may create user accounts on the online rules exchange. Users may customize their experience on the online rules exchange by filling out a user profile.

Once signed in, a user may search for rules by performing a keyword search. In some cases, the online rules exchange may include featured rules, rules sorted by categories, rules sorted by features, rules sorted by popularity metrics, and the like. In some cases, the online rules exchange may sort rules based on user preference (e.g., via user profile, learned preferences, etc.). Thus, based on the systems and methods described herein, a manufacturer may increase the utility and functionality of an automation system by enabling the general public to create and publish automation rules.

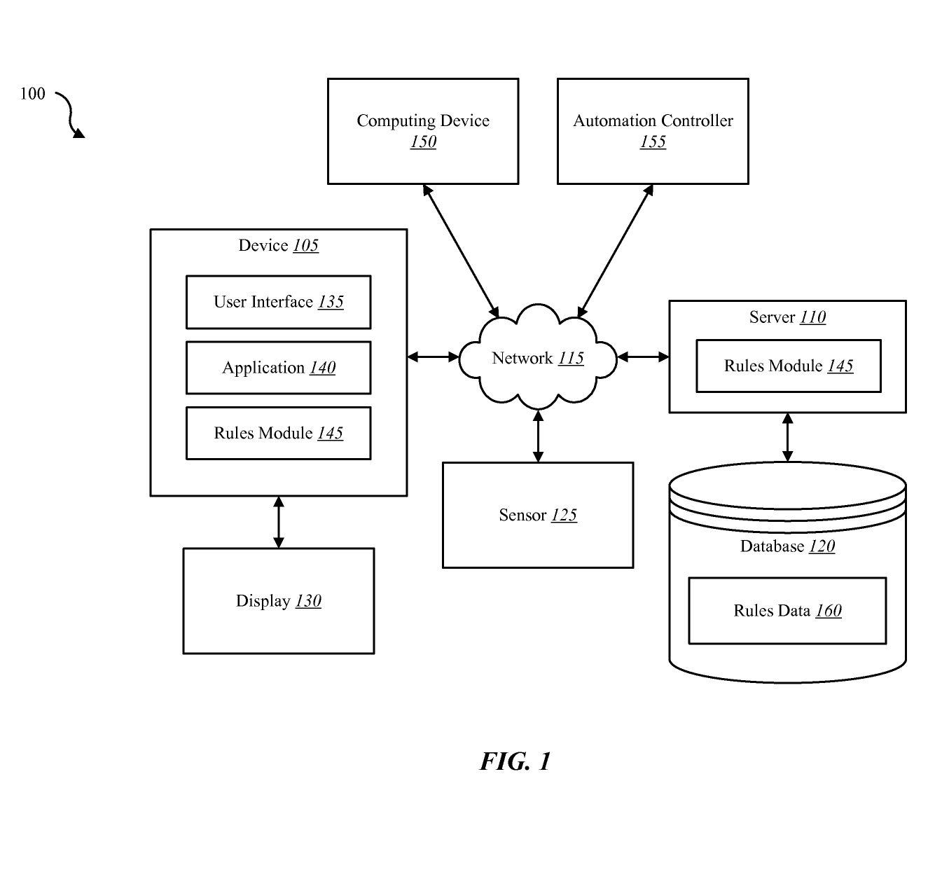

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include a device 105, server 110, a sensor 125, a display 130, a computing device 150, an automation controller 155, and a network 115 that allows the device 105, the server 110, the computing device 150, automation controller 155, and sensor 125 to communicate with one another.

Examples of the device 105 may include any combination of mobile devices, smart phones, personal computing devices, computers, laptops, desktops, servers, media content set top boxes, satellite set top boxes, cable set top boxes, DVRs, personal video recorders (PVRs), etc. In some cases, device 105 may include a building automation controller integrated within device 105, or as depicted, may be in communication with an automation controller via network 115. Examples of the automation controller 155 may include any device configured to control a building such as a home, a business, a government facility, etc. Accordingly, examples of automation controller 155 include any combination of a dedicated building automation computing device (e.g., wall-mounted controller), a personal computing device (e.g., laptop, desktop, etc.), a mobile computing device (e.g., tablet computing device, smartphone, etc.), and the like. Examples of computing device 150 may include any combination of a mobile computing device, a laptop, a desktop, a server, a media set top box, etc. Examples of server 110 may include any combination of a data server, a cloud server, a server associated with an automation service provider, proxy server, mail server, web server, application server, database server, communications server, file server, home server, mobile server, name server, etc.

Examples of sensor 125 may include any combination of a camera sensor, audio sensor, forced entry sensor, shock sensor, proximity sensor, boundary sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, temperature sensor, heartbeat sensor, breathing sensor, oxygen sensor, carbon dioxide sensor, brain wave sensor, movement sensor, voice sensor, other types of sensors, actuators, or combinations thereof. Sensor 125 may represent one or more separate sensors or a combination of two or more sensors in a single device. For example, sensor 125 may represent one or more camera sensors and one or more motion sensors connected to environment 100. Sensor 125 may be integrated with an identity detection system such as a facial recognition system and/or a voice recognition system. Although sensor 125 is depicted as connecting to device 105 over network 115, in some embodiments, sensor 125 may connect directly to or within device 105.

Additionally, or alternatively, sensor 125 may be integrated with a home appliance or fixture such as a light bulb fixture. Sensor 125 may include an accelerometer to enable sensor 125 to detect a movement. For example, sensor 125 may be carried by an occupant. Sensor 125 may include a wireless communication sensor 125 configured to send and receive data and/or information to and from one or more devices in environment 100. Additionally, or alternatively, sensor 125 may include a GPS sensor to enable sensor 125 to track a location of sensor 125 attached to an occupant and/or object. Sensor 125 may include a proximity sensor to enable sensor to detect a proximity of a person relative to an object to which the sensor is attached and/or associated. In some embodiments, sensor 125 may include a forced entry sensor (e.g., shock sensor, glass break sensor, etc.) to enable sensor 125 to detect an attempt to enter an area by force. Sensor 125 may include a siren to emit one or more frequencies of sound (e.g., an alarm).

In some configurations, the device 105 may include a user interface 135, application 140, and rules module 145. Although the components of the device 105 are depicted as being internal to the device 105, it is understood that one or more of the components may be external to the device 105 and connect to device 105 through wired and/or wireless connections. In some embodiments, application 140 may be installed on computing device 150 in order to allow a user to interface with a function of device 105, rules module 145, automation controller 155, and/or server 110.

In some embodiments, device 105 may communicate with server 110 via network 115. Example of networks 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet. It is noted that in some embodiments, the device 105 may not include a rules module 145. For example, device 105 may include application 140 that allows device 105 to interface with automation controller 155 via rules module 145 located on another device such as computing device 150 and/or server 110. In some embodiments, device 105, automation controller 155, and server 110 may include a rules module 145 where at least a portion of the functions of rules module 145 are performed separately and/or concurrently on device 105, automation controller 155, and/or server 110. Likewise, in some embodiments, a user may access the functions of device 105 and/or automation controller 155 (directly or through device 105 via rules module 145) from computing device 150. For example, in some embodiments, computing device 150 includes a mobile application that interfaces with one or more functions of device 105, automation controller 155, rules module 145, and/or server 110.

In some embodiments, server 110 may be coupled to database 120. Database 120 may be internal or external to the server 110. In one example, device 105 may be coupled directly to database 120, database 120 being internal or external to device 105. Database 120 may include rules data 160. For example, device 105 may access rules data 160 in database 120 over network 115 via server 110. Rules data 160 may include data for automation rules published on the online rules exchange. Rules data 160 may include APIs and/or SDKs for creating and/or modifying automation rules, user account information, user profiles, usage data for automation rules, rule categories, information regarding rule creators, rule features, and the like.

Rules module 145 may enable a user to create and/or modify an automation rule and upload the created/modified automation rule to an online rules exchange. Rules module 145 may enable a user to publish an uploaded automation rule on the online rules exchange, making the uploaded automation rule available to users of the online rules exchange. In some embodiments, rules module 145 may be configured to perform the systems and methods described herein in conjunction with user interface 135 and application 140. Further details regarding the rules module 145 are discussed below.

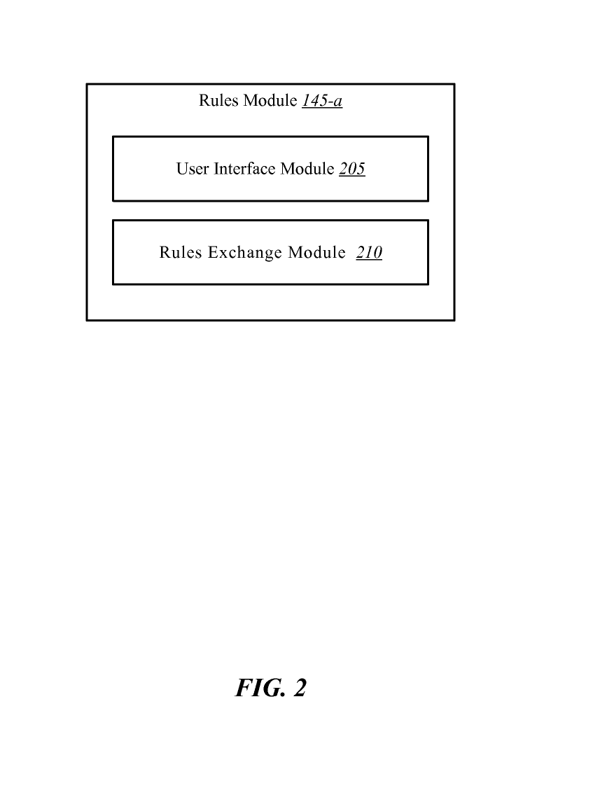

FIG. 2 is a block diagram illustrating one example of a rules module 145-a. Rules module 145-a may be one example of rules module 145 depicted in FIG. 1. As depicted, rules module 145-a may include a user interface module 205 and a rules exchange module 210.

In one embodiment, user interface module 205 may enable a user to create and/or modify an automation rule and to upload the automation rule to an online rules exchange. User interface module 205 may be configured to display automation rules on the online rules exchange in a predetermined manner. In some cases, user interface module 205 may enable a user to select an automation rule, download the selected automation rule, and install the downloaded automation rule to enable the functions of the downloaded automation in an automation system.

In some embodiments, rules exchange module 210 may receive an uploaded automation rule, evaluate the uploaded automation rule, and publish the evaluated automation rule on an online rules exchange. The rules exchange module 210 may enable a user to create a user account on the online rules exchange, enabling the user to access automation rules stored on the online rules exchange. In some cases, the rules exchange module 210 may enable a user to download an automation rule, modify the downloaded automation rule, and publish the modified automation rule on the online rules exchange. Further details regarding the user interface module 205 and rules exchange module 210 are discussed below.

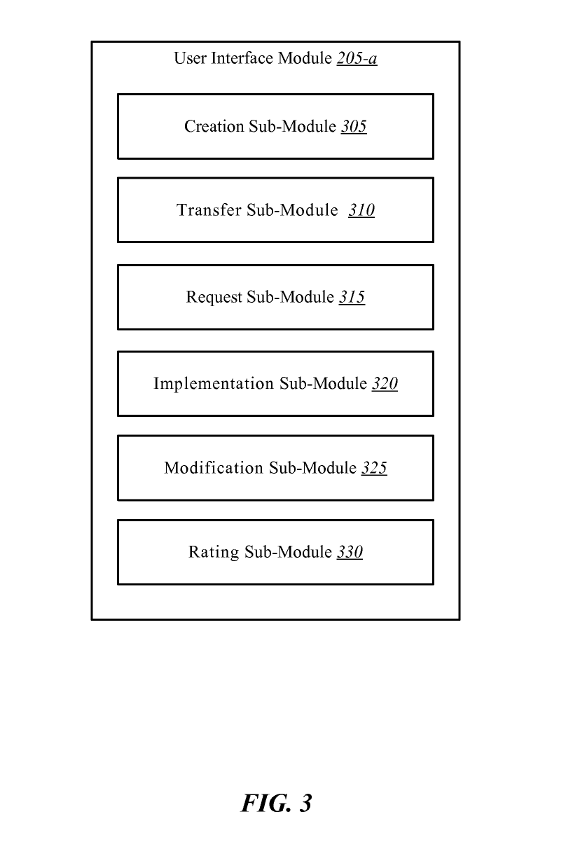

FIG. 3 is a block diagram illustrating one example of a user interface module 205-a. User interface module 205-a may be one example of user interface module 205 depicted in FIG. 2. As depicted, user interface module 205-a may include a creation sub-module 305, a transfer sub-module 310, a request sub-module 315, an implementation sub-module 320, a modification sub-module 325, and a rating sub-module 330.

In one embodiment, creation sub-module 305 may create a new building automation rule. For example, in conjunction with user interface 135, a user may create a rule for one or more system components in an automation system of a home or office. For instance, a user may create a rule for lighting, locks, motion sensors, security cameras, temperature control, smoke alarms, appliance control, etc. Once the rule is created, transfer sub-module 310 may send the new building automation rule to an online rule exchange. The online rule exchange may include a system for storing and exchanging building automation rules. The online rule exchange may enable a user to not only create and post rules on the online rule exchange, but to search and learn about automation rules. Accordingly, the online rule exchange may be configured to publish the new building automation rule, making the rule available to the public. In some cases, the online rule exchange include membership accounts. Accordingly, the downloading and installation of rules may be made available only to registered users of the online rule exchange.

In one embodiment, request sub-module 315 may send a request to the online rule exchange for information regarding one or more rules on the online rule exchange. The online rule exchange may allow users to search for rules based on rule name, categories, etc. As one example, the request may include information regarding a rule category, a rule creator, a rule name, rule popularity, a rule rating, a rule review, a featured rule, a rule description, a rule feature, a number of times a rule is downloaded, a number of users using a rule, a number of executions of a rule, and user preferences. For instance, rules may be sorted by the number of users that currently use a rule. Thus, the rule that is used the most may appear at the top of the list as the most popular rule by use, and so forth.

In some embodiments, implementation sub-module 320 may display a plurality of building automation rules from the online rule exchange in an order determined by information in the request generated by the user. For example, a user may generate a request for “temperature control rules” on the online rule exchange. The online rule exchange, in conjunction with user interface 135, may display one or more rules based on the request for “temperature control rules.” In some cases, implementation sub-module 320 may download one of the plurality of building automation rules from the online rule exchange. For example, a user may click on a listed rule. The online rule exchange may then display information regarding the selected rule, such as information regarding rule creator, rule creation date, rule updates, rule popularity, rule rating, rule reviews, rule features, rule description, rule instructions, number of times the rule has been downloaded, number of current users of this rule, and so forth. Information regarding a rule creator may include creator identity, creator popularity, creator rating, ratings of rules developed by the creator, number of rules developed by the creator, and the like. Additionally, or alternatively, the online rule exchange may display means for downloading the selected rule (e.g., a download button, etc.). The user may then download the rule and implement or install the rule in order to implement the functionality of the downloaded rule in conjunction with an automation system. In some embodiments, rating sub-module 330 may send a rating of the downloaded building automation rule to the online rule exchange. For example, in conjunction with user interface 135, a user may provide a rating and/or review of the downloaded building automation rule and via the rating sub-module 330, send the rating and/or review to be posted on the online rule exchange.

In one embodiment, modification sub-module 325 may modify the downloaded building automation rule. For example, modification sub-module 325 may enable a user to adjust one or more settings of the downloaded rule, to modify aspect of the downloaded rule, to modify software code of the downloaded rule, to merge features from the downloaded rule with features of another rule, and so forth. In some cases, transfer sub-module 310 may send the modified building automation rule to the online rule exchange. For example, after modifying a rule, the user may upload the rule to the online rule exchange, making the modified rule available to users of the online rule exchange. Thus, the online rule exchange may be configured to publish the modified building automation rule just as with the new building automation rule.

In one embodiment, modification sub-module 325 may incorporate an external service with the downloaded building automation rule. External services may include email, text messaging, social media, cloud computing, online calendars, contact lists, location services, and the like. Thus, modification sub-module 325 may enable a user to add features from an external service in the functionality of a building automation rule. For instance, a user may incorporate a function of the rule based on the reception of an email or text message from a particular contact of a contact list. Likewise, modification sub-module 325 may incorporate a user's email with a rule in order to send notifications regarding detected events triggered in accordance with a building automation rule. In some cases, modification sub-module 325 may enable a user to store recorded information in the cloud based on incorporation of cloud services in a building automation rule.

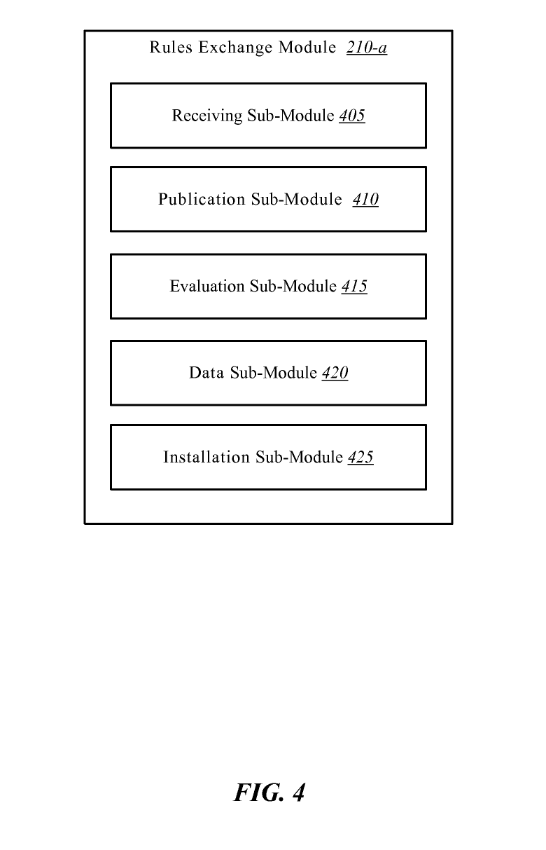

FIG. 4 is a block diagram illustrating one example of a rules exchange module 210-a. Rules exchange module 210-a may be one example of rules exchange module 210 depicted in FIG. 2. As depicted, rules exchange module 210-a may include a receiving sub-module 405, a publication sub-module 410, an evaluation sub-module 415, a data sub-module 420, and an installation sub-module 425.

In one embodiment, in conjunction with the online rule exchange, receiving sub-module 405 may receive a new building automation rule created via a user interface (e.g., user interface 135). Publication sub-module 410 may publish the new building automation rule on the online rule exchange, making the rule available to users of the online rule exchange. Upon receiving a new building automation rule, evaluation sub-module 415 may evaluate the new building automation rule. For instance, evaluation sub-module 415 may scan the new rule to determine one or more features of the new rule. As one example, evaluation sub-module 415 may determine that the new rule allows users to customize lighting schedules based on a variety of factors, etc. In some cases, evaluation sub-module 415 may scan the new rule to determine one or more categories for the new building automation rule, such as a lighting category, a doors and windows category, a temperature control category, a security camera category, a motion sensor category, an appliance control category, and the like. In one example, evaluation sub-module 415 may identify a type of sensor associated with the new rule. Accordingly, evaluation sub-module 415 may determine, without human intervention, one or more aspects of the new rule. In some cases, evaluation sub-module 415 may receive information regarding rule features and rule categories from user input. For example, in conjunction with user interface 135, evaluation sub-module 415 may display user input fields in which rule developers may enter information regarding the rule such as features, instructions, etc.

In one embodiment, data sub-module 420 may collect usage data of one or more rules on the online rule exchange. Usage data may include the number of unique downloads, number of current users, number of executions of a rule, rule reviews, rule ratings, rule popularity, rule updates, and the like. As one example, in conjunction with user interface 135 and/or application 140, data sub-module 420 may increment a tally each time the rule is triggered. In some cases, data sub-module 420 may sort the one or more rules in an order determined by an analysis of the usage data. For example, rules may be sorted by number of current users. The rule with the most current users may be at the top of a list, and so forth. The rules may be further sorted based on additional metrics, such as rule category, rule creator, rule features, etc.

In one embodiment, data sub-module 420 may learn user preferences. In one embodiment, data sub-module 420 may sort rules on the online rule exchange in an order determined by user preferences. For example, data sub-module 420 may learn that a user prefers rules regarding monitoring the elderly, monitoring a pet, monitoring a special-needs child, and so forth. Accordingly, data sub-module 420 may present rules to the user based on learned user preferences.

In some embodiments, installation sub-module 425 may receive a request to install the new building automation rule on a remote device. For example, a user on a remote device (e.g., device 105) may access the online rule exchange via user interface 135. Upon selecting a rule, the user may click on an “install” button. Upon receiving the request the installation sub-module 425 may download and install the selected rule on the remote device. In some cases, installation sub-module 425 may determine whether the remote device has one or more rules already installed on the remote device. Installation sub-module 425 may evaluate the one or more existing rules already installed on the remote device in light of the request to install the new building automation rule on the remote device. Installation sub-module 425 may determine, based on an evaluation of the one or more existing rules installed on the remote device, whether an aspect of the new building automation rule conflicts with one or more aspects of the existing rules. Upon determining the new rule conflicts with an aspect of an already-installed rule, the installation sub-module 425 may generate a notification indicating the conflict. For example, the installation sub-module 425 may generate a pop-up notification, the pop-up notification including information regarding the detected conflict. In some cases, the notification may include an option to cancel the request and/or to continue with the request. In some cases, installation sub-module 425 may perform a scan for rules on the online rules exchange that do not conflict with the rules already installed on the remote device. Upon finding one or more rules that do not conflict with the already-installed rules, installation sub-module 425 may recommend installing one of the non-conflicting rules as a substitute for the rule that was identified as conflicting with the already-installed rules.

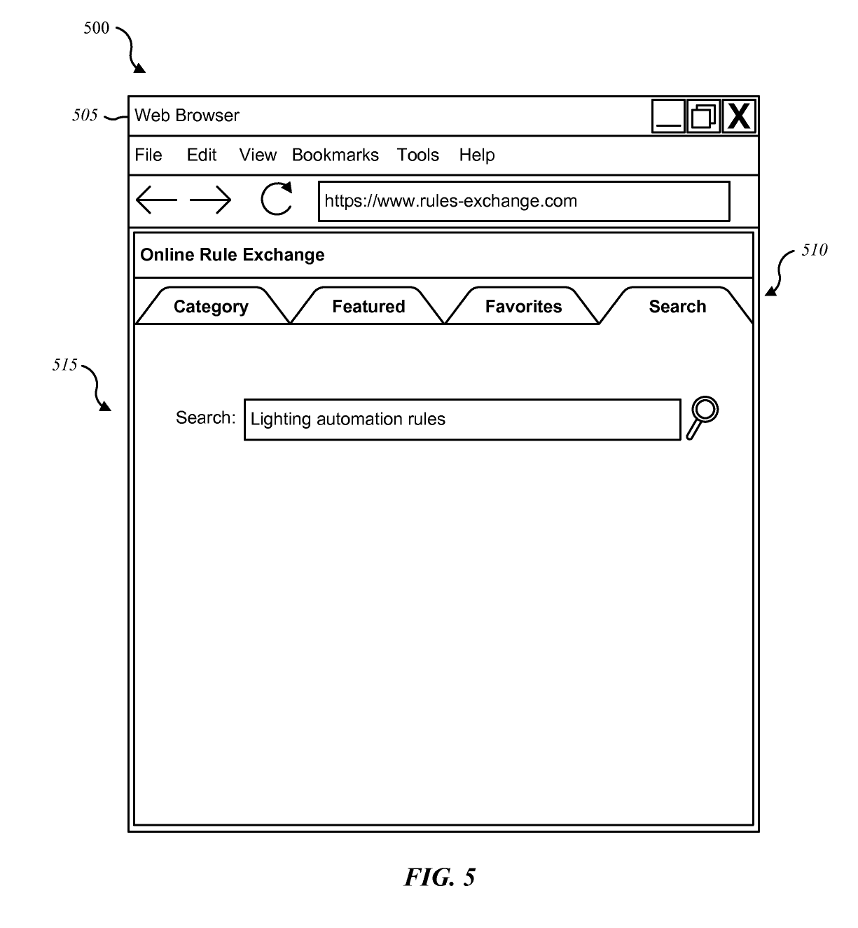

FIG. 5 is a block diagram illustrating one example of an environment 500 for crowdsourcing automation rules. As depicted, a user may access the online rules exchange via uniform resource locator (URL) entered in a browser such as browser 505. Additionally, or alternatively, a user may access the online rules exchange via a computer application, a mobile application, a web application, and the like. As depicted, a user interface of the online rules exchange may provide sorting options 510 to assist a user in finding desired automation rules. For example, the sorting options 510 may include sorting the automation rules by category, by featured rules, by favorite rules, and by performing a search. As depicted, a user may perform a search by selecting the search tab of the sorting options 510 and entering query terms into a search field 515. As illustrated, a user may search for “Lighting automation rules.” Accordingly, the online rules exchange may search for automation rules associated with lighting control, and upon finding one or more matching automation rules, may provide a display of the matching automation rules. The matching automation rules may be displayed as a list of rules, as icons in a matrix of rules, and the like.

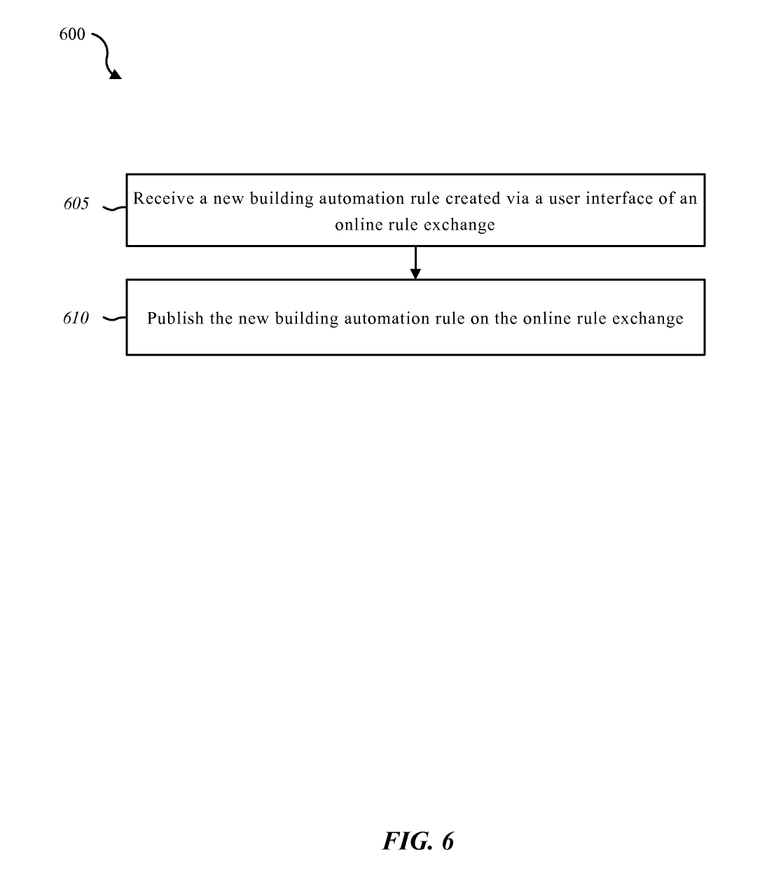

FIG. 6 is a flow diagram illustrating one embodiment of a method 600 for crowdsourcing automation rules. In some configurations, the method 600 may be implemented by the rules module 145 illustrated in FIGS. 1 and/or 2. In some configurations, the method 600 may be implemented in conjunction with the application 140 and/or the user interface 135 illustrated in FIG. 1.

At block 605, a new building automation rule may be received. The new building automation rule may be created via a user interface of an online rule exchange. At block 610, the new building automation rule may be published on the online rule exchange.

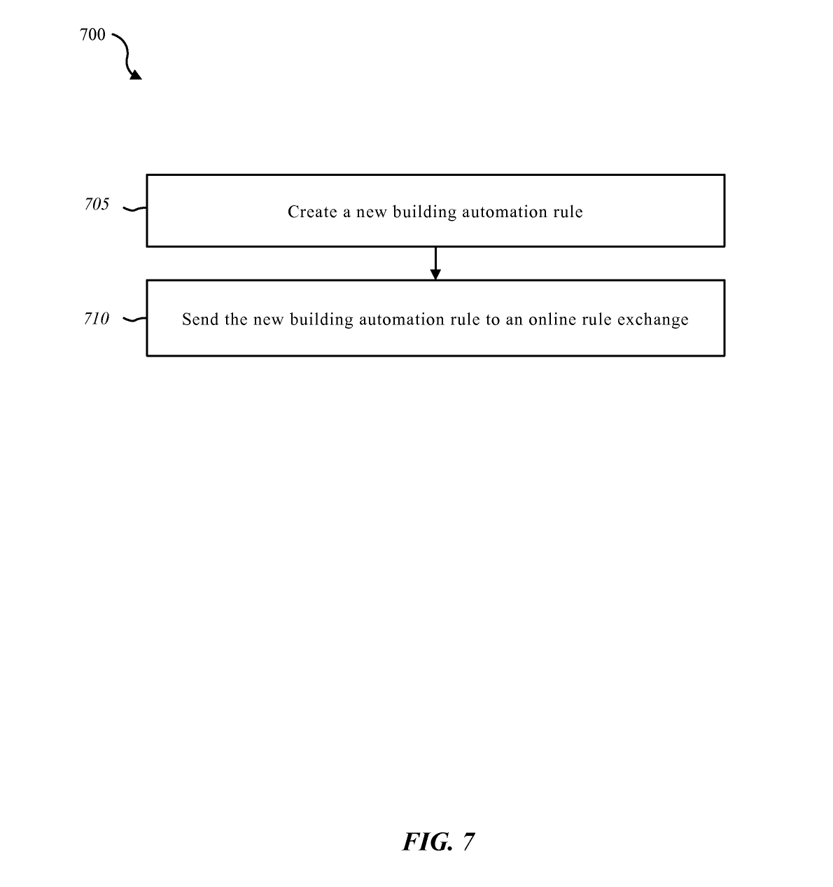

FIG. 7 is a flow diagram illustrating one embodiment of a method 700 for crowdsourcing automation rules. In some configurations, the method 700 may be implemented by the rules module 145 illustrated in FIG. 1 or 2. In some configurations, the method 700 may be implemented in conjunction with the application 140 and/or the user interface 135 illustrated in FIG. 1.

At block 705, a new building automation rule may be created. At block 710, the new building automation rule may be sent to an online rule exchange. The online rule exchange may be configured to publish the new building automation rule, making the new building automation rule available to the public and/or to members subscribing to a service of the online rule exchange.

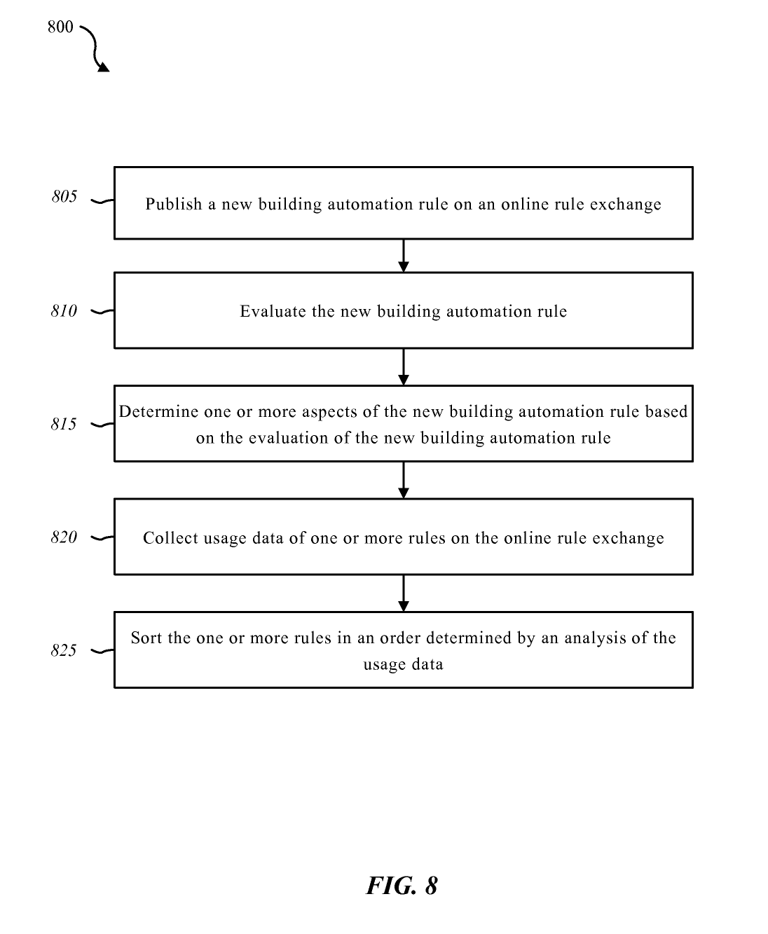

FIG. 8 is a flow diagram illustrating one embodiment of a method 800 for crowdsourcing automation rules. In some configurations, the method 800 may be implemented by the rules module 145 illustrated in FIG. 1 or 2. In some configurations, the method 800 may be implemented in conjunction with the application 140 and/or the user interface 135 illustrated in FIG. 1.

At block 805, a new building automation rule may be published on an online rule exchange. At block 810, the new building automation rule may be evaluated. At block 815, one or more aspects of the new building automation rule may be determined based on the evaluation of the new building automation rule. For instance, aspects may include a description of the rule and/or one or more features of the rule. In some cases, the new building automation rule may be assigned one or more categories according to the evaluation of the new building automation rule. Additionally, or alternatively, information regarding a rule creator, a rule name, and/or other related information may be determined. At block 820, usage data of rules on the online rule exchange may be collected. The request may include information regarding at least one of a rule category, a rule creator, a rule name, rule popularity, a rule rating, a rule review, a featured rule, a rule description, a rule feature, a number of times a rule is downloaded, a number of active users of a rule, a number of executions of a rule, and user preferences. At block 825, the one or more rules may be sorted in an order determined by an analysis of the usage data. In some cases, the one or more rules may be displayed on a user interface in the arranged order.

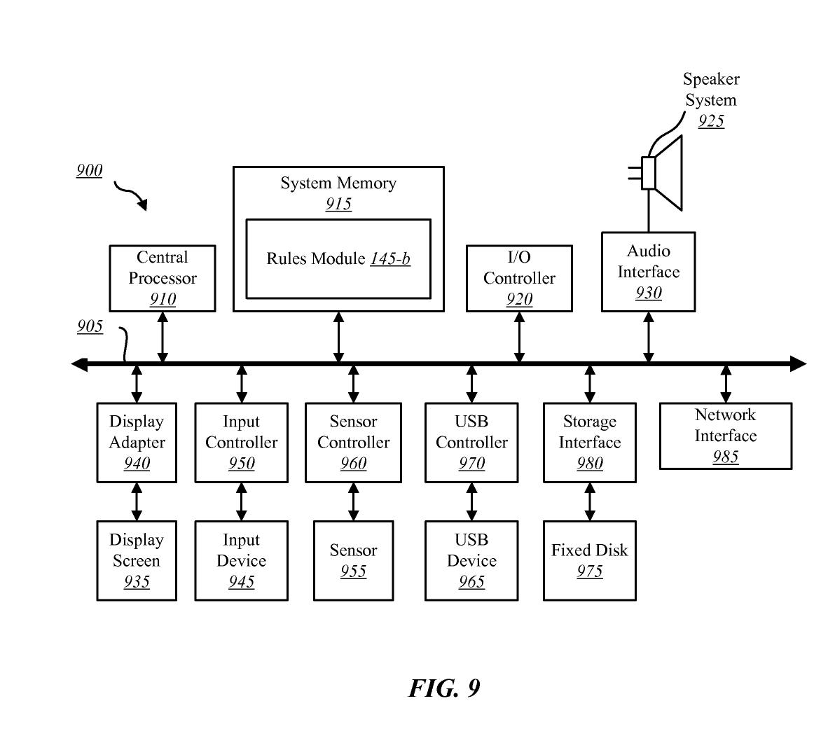

FIG. 9 depicts a block diagram of a controller 900 suitable for implementing the present systems and methods. The controller 900 may be an example of device 105, computing device 150, and/or automation controller 155 illustrated in FIG. 1. In one configuration, controller 900 includes a bus 905 which interconnects major subsystems of controller 900, such as a central processor 910, a system memory 915 (typically RAM, but which may also include ROM, flash RAM, or the like), an input/output controller 920, an external audio device, such as a speaker system 925 via an audio output interface 930, an external device, such as a display screen 935 via display adapter 940, an input device 945 (e.g., remote control device interfaced with an input controller 950), multiple USB devices 965 (interfaced with a USB controller 970), and a storage interface 980. Also included are at least one sensor 955 connected to bus 905 through a sensor controller 960 and a network interface 985 (coupled directly to bus 905).

Bus 905 allows data communication between central processor 910 and system memory 915, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the rules module 145-b to implement the present systems and methods may be stored within the system memory 915. Applications (e.g., application 140) resident with controller 900 are generally stored on and accessed via a non-transitory computer readable medium, such as a hard disk drive (e.g., fixed disk 975) or other storage medium. Additionally, applications can be in the form of electronic signals modulated in accordance with the application and data communication technology when accessed via interface 985.

Storage interface 980, as with the other storage interfaces of controller 900, can connect to a standard computer readable medium for storage and/or retrieval of information, such as a fixed disk drive 975. Fixed disk drive 975 may be a part of controller 900 or may be separate and accessed through other interface systems. Network interface 985 may provide a direct connection to a remote server via a direct network link to the Internet via a POP (point of presence). Network interface 985 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 900 wirelessly via network interface 985.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 9 need not be present to practice the present systems and methods. The devices and subsystems can be interconnected in different ways from that shown in FIG. 9. The aspect of some operations of a system such as that shown in FIG. 9 are readily known in the art and are not discussed in detail in this application. Code to implement the present disclosure can be stored in a non-transitory computer-readable medium such as one or more of system memory 915 or fixed disk 975. The operating system provided on controller 900 may be iOS®, ANDROID®, MS-DOS®, MS-WINDOWS®, OS/2®, UNIX®, LINUX® or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for crowdsourcing automation rules, comprising:
receiving a building automation rule created via a user interface of an online rule exchange; and
publishing the building automation rule on the online rule exchange.

2. The method of claim 1, further comprising:
evaluating the building automation rule.

3. The method of claim 2, further comprising:
determining one or more features of the building automation rule based at least in part on the evaluation.

4. The method of claim 2, further comprising:
determining one or more categories for the building automation rule based at least in part on the evaluation.

5. The method of claim 1, further comprising:
collecting usage data of one or more rules on the online rule exchange.

6. The method of claim 5, further comprising:
sorting the one or more rules in an order determined by an analysis of the usage data.

7. The method of claim 1, further comprising:
learning user preferences; and
sorting rules on the online rule exchange in an order determined by user preferences.

8. The method of claim 1, further comprising:
receiving a request to install the building automation rule on a remote device; and
determining, based on an evaluation of an existing rule installed on the remote device, whether an aspect of the building automation rule conflicts with an aspect of the existing rule.

9. A method for crowdsourcing automation rules, comprising:
creating a building automation rule; and
sending the building automation rule to an online rule exchange, the online rule exchange being configured to publish the building automation rule.

10. The method of claim 9, further comprising:
sending a request to the online rule exchange for information regarding one or more rules on the online rule exchange.

11. The method of claim 10, wherein the request comprises information regarding at least one of a rule category, a rule creator, a rule name, rule popularity, a rule rating, a rule review, a featured rule, a rule description, a rule feature, a number of times a rule is downloaded, a number of current users of a rule, a number of executions of a rule, and user preferences.

12. The method of claim 11, further comprising:
displaying a plurality of building automation rules from the online rule exchange in an order determined by information in the request; and
downloading one of the plurality of building automation rules from the online rule exchange.

13. The method of claim 12, further comprising:
modifying the downloaded building automation rule; and
sending the modified building automation rule to the online rule exchange, the online rule exchange being configured to publish the modified building automation rule.

14. The method of claim 12, further comprising:
incorporating an external service with the downloaded building automation rule, wherein the external service includes at least one setting associated with at least one of an email account, a text messaging account, a cloud computing account, a social media account, an online calendar, a contact list, and a location service.

15. The method of claim 12, further comprising:
sending a rating of the downloaded building automation rule to the online rule exchange.

16. A computing device configured for crowdsourcing automation rules, comprising:
a processor;
memory in electronic communication with the processor, wherein the memory stores computer executable instructions that when executed by the processor cause the processor to:
receive a building automation rule created via a user interface of an online rule exchange; and
publish the building automation rule on the online rule exchange.

17. The computing device of claim 16, wherein the instructions executed by the processor cause the processor to:
evaluate the building automation rule.

18. The computing device of claim 17, wherein the instructions executed by the processor cause the processor to:
determine one or more features of the building automation rule based on the evaluation of the new building automation rule.

19. The computing device of claim 17, wherein the instructions executed by the processor cause the processor to:
determine one or more categories for the building automation rule based on the evaluation of the building automation rule.

20. The computing device of claim 16, wherein the instructions executed by the processor cause the processor to:
collect usage data of one or more rules on the online rule exchange; and
sort the one or more rules in an order determined by an analysis of the usage data.
